(19) United States
(12) Patent Application Publication
(10) Pub. No.: US 2016/0330023 A1
(43) Pub. Date: Nov. 10, 2016

(54) ID GENERATING DEVICE, ID GENERATING METHOD, AND ID GENERATING SYSTEM

(71) Applicant: Kabushiki Kaisha Toshiba, Minato-ku (JP)

(72) Inventors: Tetsufumi TANAMOTO, Kawasaki (JP); Shinichi YASUDA, Setagaya (JP); Shinobu FUJITA, Inagi (JP)

(73) Assignee: Kabushiki Kaisha Toshiba, Minato-ku (JP)

(21) Appl. No.: 15/193,354

(22) Filed: Jun. 27, 2016

Related U.S. Application Data
(63) Continuation of application No. PCT/JP2014/074730, filed on Sep. 18, 2014.

(30) Foreign Application Priority Data
Dec. 27, 2013 (JP) 2013-273275

(51) Int. Cl. H04L 9/08; G06F 7/58

(52) U.S. Cl. CPC H04L 9/0861; G06F 7/588; G06F 2207/58

(57) ABSTRACT

According to an embodiment, an ID generating device includes a random number generator, a storage, and a generator. The random number generator is configured to generate random numbers. The storage is configured to store the random numbers generated by the random number generator during a predetermined time period starting from activation of the random number generator. The generator is configured to generate identification information using the random numbers stored in the storage.

### CROSS-REFERENCE TO RELATED APPLICATIONS

This application is a continuation of PCT international application Ser. No. PCT/JP2014/074730 filed on Sep. 18, 2014 which designates the United States, incorporated herein by reference, and which claims the benefit of priority from Japanese Patent Applications No. 2013-273275, filed on Dec. 27, 2013, incorporated herein by reference.

### FIELD

Embodiments described herein relate generally to an ID generating device, an ID generating method, and an ID generating system.

### BACKGROUND

The use of near field communication (NFC) is on the rise. Moreover, the use of IC (Integrated Circuit) cards, such as cash cards or credit cards, as electronic money is also increasing. Furthermore, IC cards are being often used in tickets of trains or buses. In such IC cards, the ID (identification) function for identifying individuals assumes importance. Besides, in the present-day life in which the use of IC cards is on the rise, bolstering the security assumes more importance. Even in the case of memory cards that were used with the sole purpose of storing data, the ID function is being increasingly provided. Hence, there is a demand for achieving sophistication of the ID function in portable devices.

Meanwhile, research and development is being performed to make use of variability of individual devices as “chip fingerprint”. For example, a method (SRAM-PUF: Physically Unclonable Function) is known for distinguishing an ID using the initial variability of an SRAM (Static Random Access Memory) or using crystal defects during the factory shipment. Moreover, a method is known in which the differences between the frequencies of a large number of ring oscillators is used as IDs.

However, in the SRAM-PUF, the memory area for a number of SRAMs is required, thereby possibly leading to an overhead of the circuit area. Moreover, in the method in which the differences between the frequencies of a large number of ring oscillators is used as IDs, a large number of ring oscillators each having three or more inverters need to be unnecessarily installed. Hence, after all, a lot of unnecessary circuit area is required.

### BRIEF DESCRIPTION OF THE DRAWINGS

FIG. 1 is a block diagram of an ID generating system according to a first embodiment;

FIG. 2 is a circuit diagram of a ring oscillator disposed in the ID generating system according to the first embodiment;

FIG. 3 is a diagram for explaining the timing of ID generation in the ID generating system according to the first embodiment;

FIG. 4 is a diagram for explaining random number generation cycles and bit patterns in the ID generating system according to the first embodiment;

FIG. 5 is a diagram for explaining a flow of ID generation in the ID generating system according to the first embodiment;

FIG. 6 is a circuit diagram of a ring oscillator in an ID generating system according to a second embodiment;

FIG. 7A is a circuit diagram of a ring oscillator, which includes a single gate for delaying the oscillation speed, in the ID generating system according to a fourth embodiment;

FIG. 7B is a circuit diagram of another ring oscillator, which includes a single gate for delaying the oscillation speed, in the ID generating system according to the fourth embodiment;

FIG. 7C is a circuit diagram of a ring oscillator, which includes a single gate for delaying the oscillation speed but which is different than the ring oscillators illustrated in FIG. 7A and FIG. 7B, in the ID generating system according to the fourth embodiment;

FIG. 7D is a circuit diagram of a ring oscillator, which includes a single XOR gate for delaying the oscillation speed, in the ID generating system according to a fourth embodiment;

FIG. 8A is a circuit diagram of a ring oscillator, which includes two or three gates for delaying the oscillation speed, in the ID generating system according to the fourth embodiment;

FIG. 8B is a circuit diagram of another ring oscillator, which includes two or three gates for delaying the oscillation speed, in the ID generating system according to the fourth embodiment;

FIG. 8C is a circuit diagram of a ring oscillator, which includes two or three gates for delaying the oscillation speed but which is different than the ring oscillators illustrated in FIG. 8A and FIG. 8B, in the ID generating system according to the fourth embodiment;

FIG. 8D is a circuit diagram of another ring oscillator, which includes OR gates for delaying the oscillation speed, in the ID generating system according to the fourth embodiment;

FIG. 9A is a circuit diagram of a modification example of the ring oscillator, which includes two or three gates for delaying the oscillation speed, in the ID generating system according to the fourth embodiment;

FIG. 9B is a circuit diagram of another modification example of the ring oscillator, which includes two or three gates for delaying the oscillation speed, in the ID generating system according to the fourth embodiment;

FIG. 9C is a circuit diagram of another modification example of a ring oscillator, which includes two or three gates for delaying the oscillation speed but which is different than the ring oscillators illustrated in FIG. 9A and FIG. 9B, in the ID generating system according to the fourth embodiment;

FIG. 9D is a circuit diagram of another modification example of a ring oscillator, which includes two or three gates for delaying the oscillation speed but which is different than the ring oscillators illustrated in FIG. 9A to FIG. 9C, in the ID generating system according to the fourth embodiment;

FIG. 10 is a block diagram for explaining a flow ID generation from the differences between the outputs of neighboring ring oscillators in the ID generating system according to a fifth embodiment;

FIG. 11 is a block diagram for explaining a flow ID generation by obtaining further differences from the differences between the outputs of neighboring ring oscillators in the ID generating system according to the fifth embodiment;

FIG. 12 is a block diagram for explaining a flow ID generation from the differences between the outputs of neighboring registers in the ID generating system according to the fifth embodiment;

FIG. 13 is a diagram illustrating an example of use in which the ID generating system according to the embodiments is implemented in an IC card;

FIG. 14 is a diagram illustrating an example of use in which the ID generating system according to the embodiments is implemented in a mobile terminal;

FIG. 15 is a diagram illustrating an example of use in which the ID generating system according to the embodiments is implemented in machine-to-machine (M2M) two-way authentication;

FIG. 16 is a diagram illustrating another example of use in which the ID generating system according to the embodiments is implemented in machine-to-machine (M2M) two-way authentication;

FIG. 17 is a block diagram of an electronic device in which the ID generating system according to the embodiments is implemented;

FIG. 18 is a block diagram of an ID generating system according to a sixth embodiment; and

FIG. 19 is a block diagram of an ID generating system according to a seventh embodiment.

### DETAILED DESCRIPTION

According to an embodiment, an ID generating device includes a random number generator, a storage, and a generator. The random number generator is configured to generate random numbers. The storage is configured to store the random numbers generated by the random number generator during a predetermined time period starting from activation of the random number generator. The generator is configured to generate identification information using the random numbers stored in the storage.

Exemplary embodiments of an ID generating device, an ID generating method, and an ID generating system are described below in detail with reference to the accompanying drawings. Herein, ID stands for “identification”.

General Outline

An ID generating device, an ID generating method, and an ID generating system according to the embodiments enable generation of a more robust ID by not only using singular information such as defect information unique to each device but also using a plurality of physical properties of the ID generating device. Particularly, just by adding a small-scale circuit to random number generating circuits that are essentially used in generating random numbers, a circuit is provided that has a random number generation function as well as an ID generation function. Then, the statistical property of the random numbers generated by the random number generating circuits and a bit string of random numbers generated in the first place by the random number generating circuits (i.e., a bit string at the rising) are combined to generate a safer and more robust ID.

### First Embodiment

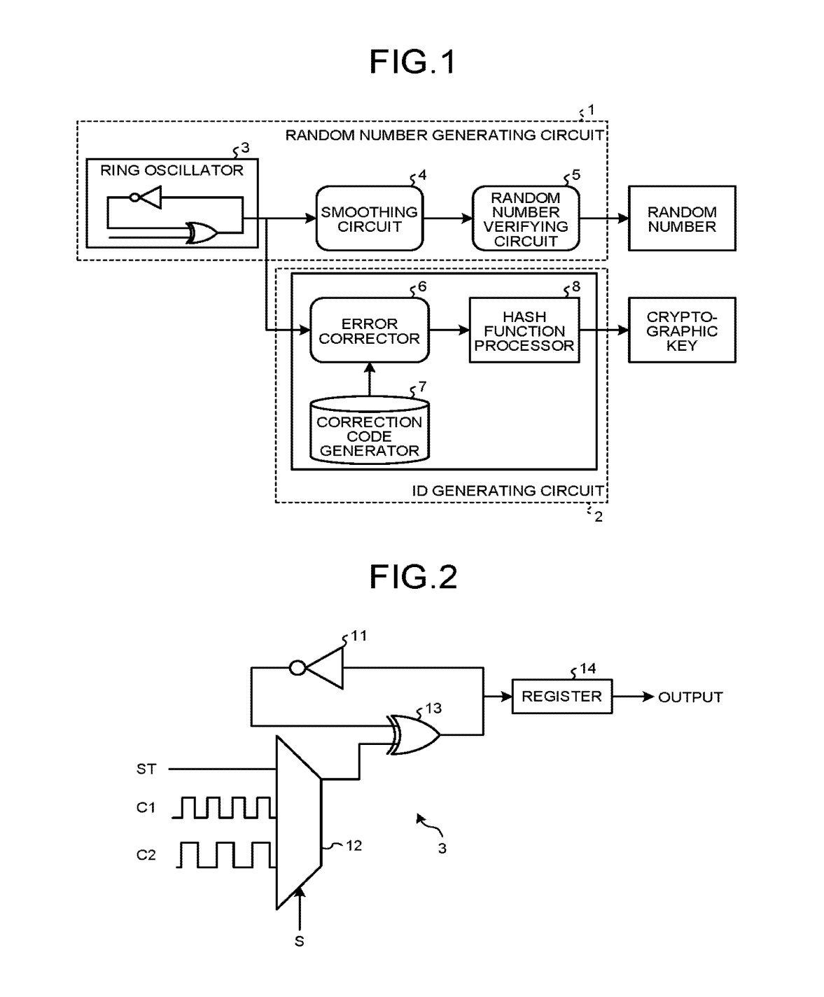

Firstly, in FIG. 1 is illustrated a block diagram of an ID generating system according to a first embodiment. The ID generating system includes a random number generating circuit 1 and an ID generating circuit 2. The random number generating circuit 1 includes a ring oscillator 3, a smoothing circuit 4, and a random number verifying circuit 5. Although described later in detail, the ring oscillator 3 includes an uneven number of inverters connected in a ring-like manner, as well as includes a selector for oscillation adjustment and a register for ID generation. The ring oscillator 3 is an example of a random number generator. As far as the random number generator is concerned, any component capable of generating random numbers can be used in place of the ring oscillator 3. Meanwhile, it is not necessary to dispose the smoothing circuit 4. However, it is desirable that the smoothing circuit 4 is used when there is variability in the data generated at the start of operations. The smoothing circuit 4 averages bit patterns of 0 and bit patterns of 1. The random number verifying circuit 5 performs, for example, “degree verification” in which the frequency of appearance of random numbers is subjected to chi-square verification, and outputs random numbers.

The ID generating circuit 2 is an example of a generator. The ID generating circuit 2 includes an error corrector 6 that performs output correction (described later) with respect to the random numbers generated by the ring oscillator 3, and performs output by adding an error correction code supplied by a correction code generator 7. Moreover, the ID generating circuit 2 also includes a hash function processor 8 that generates a cryptographic key by applying a hash function to the output from the error corrector 6, and outputs the cryptographic key.

FIG. 2 is a circuit diagram of the ring oscillator 3. In the first embodiment, the explanation is given under the assumption that the ID generating system includes a plurality of ring oscillators 3. However, it is also possible to have only a single ring oscillator 3. As described later, the ID generating system according to the first embodiment generates an ID using the random numbers generated by a plurality of ring oscillators 3. As illustrated in FIG. 2, each ring oscillator 3 includes an uneven number of inverters 11 connected in a ring-like manner; a selector 12 for oscillation adjustment; and an XOR gate 13 that outputs the exclusive OR of each output of the inverter 11 and the selector 12. Herein, XOR stands for “exclusive OR”. Meanwhile, each ring oscillator 3 also includes a register 14 that is used at the time of generating an ID from the random numbers output by the XOR gate 13. Herein, the register 14 is an example of a storage. For example, the register 14 includes a flip-flop, and is used in storing bit patterns of 0 or bit patterns of 1 output from the XOR gate 13.

Meanwhile, instead of using the register 14, it is possible to use a memory such as an SRAM or a DRAM. Herein, SRAM stands for “Static Random Access Memory”; and DRAM stands for Dynamic Random Access Memory. Moreover, instead of using an SRAM or a DRAM, it is possible to use a nonvolatile memory such as a flash memory. In the case of using a nonvolatile memory, in order to ensure the confidentiality of an ID; it is desirable that, after the ID generating circuit 2 has completed generating the ID, the ID data stored in the nonvolatile memory is deleted.

As illustrated in FIG. 2, the selector 12 is supplied with an oscillation termination signal ST used in performing termination control with respect to the ring oscillator 3; and is supplied with two types of clocks C1 and C2 that have different frequencies. Of the oscillation termination signal ST and the two types of clocks C1 and C2, the selector 12 selects either the oscillation termination signal ST or the clocks C1 and C2 according to a selection signal S, and sends the selection to the XOR gate 13.

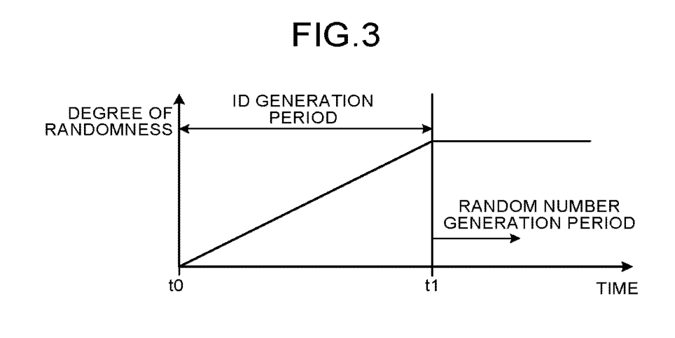

Then, according to clock timings set externally, the ring oscillator 3 distributes 0 and 1 in a stochastically random manner, and operates as the principal component of the random number generating circuit 1. As illustrated in FIG. 3, from the time at which the ID generating system is switched ON up to the time at which random numbers having sufficient entropy are generated, the ring oscillator 3 requires a proportionate period of time. That is, if it is assumed that the ID generating system is switched ON at a timing t0, then random numbers having sufficient entropy are generated from a timing t1 after the elapse of a proportionate period of time. This “proportionate period of time” is, for example, the period of time equivalent to 100 clocks. After the elapse of a sufficient period of time (after the timing t1), the random numbers generated by the ring oscillator 3 improve in quality due to the effect of the surrounding noise.

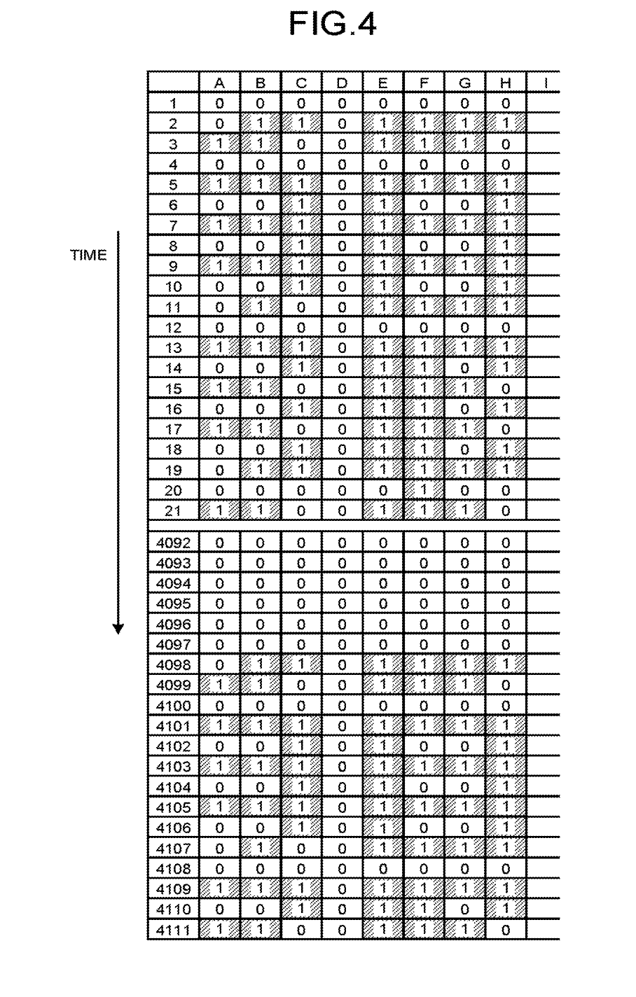

Usually, the random numbers that are generated between the timing t0 and the timing t1 illustrated in FIG. 3 are destroyed. However, the random numbers generated from the timing t0, at which the ID generating system is switched ON, to the timing t1, at which the generation of stable random numbers starts, have a generation pattern unique to each ring oscillator 3. Meanwhile, the state in which the stable random numbers are generated represents a state in which there is almost no temporal variation in the frequency of appearance of “0” and “1”. That is, it represents a state in which a substantial variation (for example, variation of 20% or greater) is no more seen in the statistic of “0” and “1”. In FIG. 4 are illustrated random numbers that are generated between the timing t0 and the timing t1 by a total of eight ring oscillators 3 from A to H. In the example illustrated in FIG. 4, the eight ring oscillators 3 from A to H are oscillated before the oscillation is temporarily stopped (indicating a section in which all data are 0). Then, the eight ring oscillators 3 from A to H are oscillated again. As can be seen by comparing the random numbers before and after stopping the oscillation, each ring oscillator 3 has a unique pattern of generating random numbers between the timing t0 and the timing t1.

In this way, in the ID generating system according to the first embodiment, the usually-unused period of time between the timing t0, which represents the start time, and the timing t1, at which the generation of stable random numbers starts, is used for the purpose of ID generation (an ID generation period). More particularly, during the ID generation period, because of the unique patterns of generating random numbers, regarding the timing of obtaining the random numbers to be used in ID generation, the random numbers generated at a desired timing can be obtained. In the ID generating system according to the first embodiment, as an example, the random number generated in the first place after running each ring oscillator 3 (i.e., the random number generated immediately after the activation) is stored in the corresponding register 14 and is used in ID generation. In the example illustrated in FIG. 4, the random numbers generated immediately after the activation represent a bit string “01101111” generated by the ring oscillators 3 from A to H. If the bias in 0 and 1 of such random numbers as well as the bit strings of 0 and 1 generated immediately after the activation (at the start) are treated as the ID, then it becomes possible to bolster the identification. Meanwhile, instead of using a plurality of ring oscillators 3, if only a single ring oscillator 3 is disposed; then, with reference to the example illustrated in FIG. 4, the ID is generated with the random number generated only by the ring oscillator 3 of A. Hence, a one-bit ID of “1” or “0” is generated. In FIG. 2 is illustrated a configuration including a single ring oscillator 3. In that case, the number of registers 14 is also one. In contrast, in the example illustrated in FIG. 4, the number of ring oscillators 3 illustrated in FIG. 2 is eight, and the number of registers 14 is also eight. If the register 14 is replaced with a memory, then the memory can be divided into eight memory areas. Similarly, if the registers 14 are replaced with two memories, then each memory can be divided into four memory areas.

Subsequently, the ring oscillator 3 illustrated in FIG. 2 performs ID generation and random number generation at the same time. That is, as illustrated in FIG. 2, the selector 12 is provided with a fixed value (an oscillation termination signal ST); is provided with the clock C1 having the same frequency as the operating frequency; and is provided with the clock C2 obtained by dividing the frequency of a clock signal same as the operating frequency. Of the oscillation termination signal ST and the clocks C1 and C2, the selection is done according to the selection signal S.

Meanwhile, in FIG. 2, it is illustrated that the oscillation termination signal ST, the operating frequency clock C1, and the frequency division clock C2 are input to the selector 12. However, alternatively, the oscillation termination signal ST and one of the two clocks C1 and C2 can be input to the selector 12. In the case of having such two inputs, if the clock frequency has been subjected to frequency division, then the output data of the ring oscillator 3 may be thinned according to the frequency division. For example, in the case in which the clock frequency is divided into two, if the output data of the ring oscillator is obtained for every two clocks, then identical data can be obtained when the input clock is same as the clocks for the other portions of the circuit. Meanwhile, it is also possible to detect rising of the clock or falling of the clock. Regarding which of the two is to be detected, the decision can be taken according to the matching with the other circuit portions.

As explained with reference to FIG. 3, usually, the random number generating circuit 1 illustrated in FIG. 2 requires a certain period of time until generation of stable random numbers starts. In FIG. 3, it is illustrated that the degree of randomness, such as entropy, is transitioned to a linear form. However, the transition is not limited to linear transition. In the ID generating system according to the first embodiment, as described above, the ID is generated using random numbers generated at a predetermined timing (for example, random numbers generated immediately after the activation) during the usually-unused period of time from the starting time at the timing t0 to the timing t1 at which generation of random numbers having sufficient entropy starts.

More particularly, in the ID generating system according to the first embodiment, the register 14 including, for example, a flip-flop is disposed subsequent to each ring oscillator 3. Then, the random number generated by each ring oscillator 3 immediately after activation is stored in the corresponding register 14, and the ID generating circuit 2 generates an ID using the random numbers stored in the registers 14. The length of the generated ID corresponds to the bit count required by an encryption circuit disposed at a later level. For example, consider a case in which the bit count equivalent to the number of registers 14 is 64 bits. In the case in which the data quantity required for ID generation is 64 bits; firstly, from among a plurality of ring oscillators 3, the ring oscillators 3 having the highest ID generation capacity can be selected and used. If a 256-bit key is required, then 64 bits generated by four ring oscillators 3 at the start of operations can be selected from and combined to generate a 256-bit key. Herein, the number of used ring oscillators 3 can be greater or smaller.

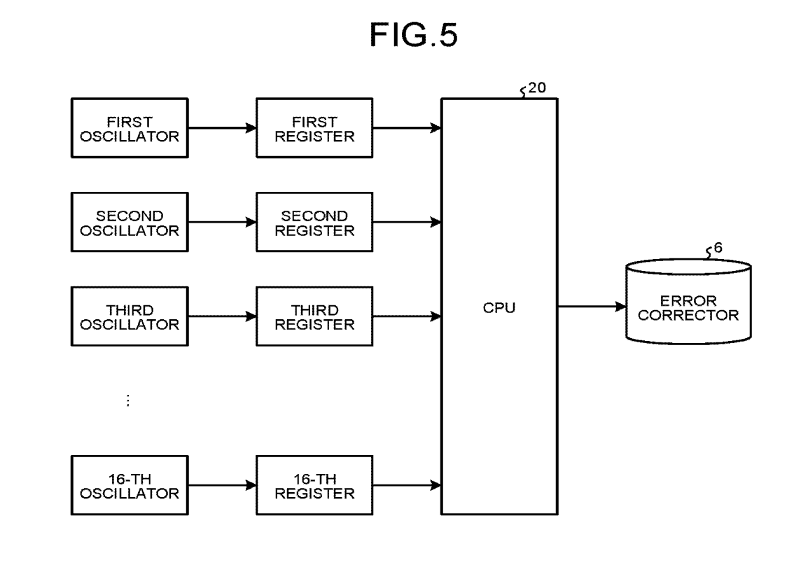

In FIG. 5 is illustrated an example of generating an ID using a total of 16 ring oscillators 3 from a first oscillator to a 16-th oscillator. A CPU 20 of the ID generating circuit 2 generates an ID using the value stored in each of a first register to a 16-th register that are disposed subsequent to the first oscillator to the 16-th oscillator, respectively. For example, the CPU 20 generates an ID by independently using a bit string of the random numbers generated by the first oscillator to the 16-th oscillator immediately after the activation thereof. Alternatively, the CPU 20 combines the random numbers generated by the first oscillator to the 16-th oscillator that are arranged in parallel, and generates an ID having a long bit string.

As is clear from the explanation given till now, in the ID generating system according to the first embodiment, an ID is generated using the random numbers generated by one or more ring oscillators 3 immediately after the activation thereof. As a result, with the combination of the statistical property and the rising, generation of a safer and more robust ID can be made possible.

Moreover, in the ID generating system according to the first embodiment, the random number generated by each ring oscillator 3 can be used in an ID. That eliminates the need of having a dedicated circuit for ID generation and having a large memory for ID generation. Hence, a simple and affordable ID generating system can be implemented.

### Second Embodiment

Given below is the explanation of an ID generating system according to a second embodiment. In the first embodiment, it was explained that the smoothing circuit 4 illustrated in FIG. 1 need not be disposed. In contrast, the ID generating system according to the second embodiment is an example in which the smoothing circuit 4 is disposed. As compared to the first embodiment, the second embodiment differs regarding only this point. Hence, the following explanation is given only about the differences between the two embodiments, and the redundant explanation is not repeated.

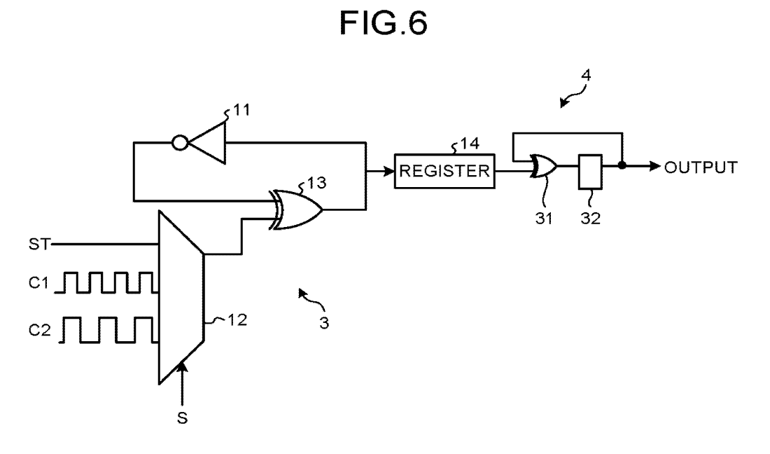

FIG. 6 is a circuit diagram of the ring oscillator 3 in the ID generating system according to the second embodiment. As illustrated in FIG. 6, in each ring oscillator 3 in the ID generating system according to the second embodiment, the smoothing circuit 4 is disposed for smoothing of the output data of the ring oscillator 3 read from the corresponding register 14. More particularly, the smoothing circuit 4 includes an XOR gate 31 and a flip-flop 32. Herein, the flip-flop 32 delays the output data of the corresponding ring oscillator 3 by, for example, a single clock and outputs the delayed output data. The XOR gate 31 compares the current output data of the ring oscillator 3 with the output data of the ring oscillator 3 that has been delayed by a single clock by the flip-flop 32 (i.e., the output data of the previous clock), and sends the comparison result in the form of data of 1 or 0 to the flip-flop 32.

Depending on the oscillation environment of the ring oscillator 3, there are times when the random numbers generated at the start of operations exhibit variability. In such a case, the smoothing circuit 4 is disposed to perform smoothing of the data generated at the start of operations of the ring oscillator 3. As a result, it becomes possible to hold down the variability in the random numbers generated at the start of operations of the ring oscillator 3.

Meanwhile, as far as the smoothing circuit 4 is concerned, it is possible to use a smoothing circuit in which a rejection method is implemented for rejecting the continuing bits. In a smoothing circuit in which the rejection method is implemented, 00 and 11 are determined to be 0, while 01 and 10 are determined to be 1. Moreover, regardless of whether a plurality of ring oscillators 3 is disposed or a single ring oscillator 3 is disposed, it is possible to achieve the effect described above.

### Third Embodiment

Given below is the explanation of an ID generating system according to a third embodiment. In the ID generating system according to the third embodiment, it is possible to correct the initial variability and the statistical changes occurring in the output data of the ring oscillator 3 due to the age-related deterioration. As compared to the embodiments described above, the third embodiment differs regarding only this point. Hence, the following explanation is given only about the differences between the embodiments, and the redundant explanation is not repeated.

In the ID generating system according to the third embodiment; deterioration information, which indicates the initial variability and the statistical changes occurring in the output data of the ring oscillator 3 due to the age-related deterioration, is stored in the correction code generator 7 illustrated in FIG. 1. The error corrector 6 performs error correction using the deterioration information received from the correction code generator 7, and corrects the ID generated by the CPU 20. As a result, the same ID can be generated on a constant basis in response to the initial variability and the statistical changes occurring in the output data of the ring oscillator 3 due to the age-related deterioration. Moreover, regardless of whether a plurality of ring oscillators 3 is disposed or a single ring oscillator 3 is disposed, it is possible to achieve the effect described above.

### Fourth Embodiment

Given below is the explanation of an ID generating system according to a fourth embodiment. The ID generating system according to the fourth embodiment is an example in which a delay circuit is disposed for delaying the oscillation speed of each ring oscillator 3. As compared to the embodiments described above, the fourth embodiment differs regarding only this point. Hence, the following explanation is given only about the differences between the embodiments, and the redundant explanation is not repeated.

In the case of using the ring oscillators 3 in generating random numbers, usually the circuit is designed using a layout routing tool. At that time, in order to enhance the operating speed of the ring oscillators 3, the number of inverters 11 in each ring oscillator 3 is often kept down to one. However, if the frequency of ring oscillation is too fast for the input clock, then the period of time taken for achieving total variability in the randomness of 0 and 1 becomes shorter, which may pose an obstacle in ID generation described above.

In that regard, in the ID generating system according to the fourth embodiment, a circuit (a gate) is disposed in each ring oscillator 3 for the purpose of delaying the frequency of ring oscillation to a certain extent. As far as the circuit to be newly inserted is concerned, it is suitable to use, for example, an AND circuit, an OR circuit, an XOR circuit, or a combination of such circuits. However, if the added circuits become excessive, then it may result in a decline in the oscillation frequency of the ring oscillator 3. Hence, it is desirable that the added circuits are not excessive.

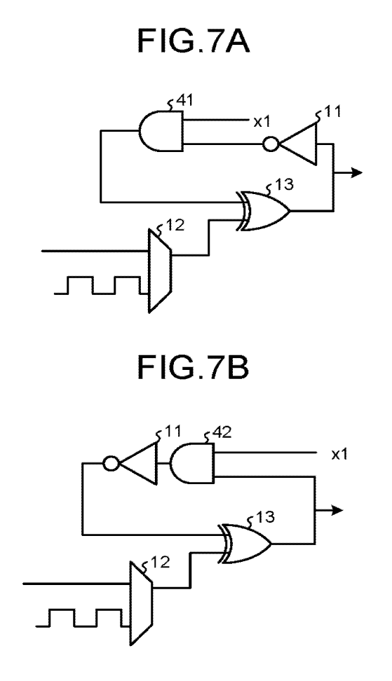

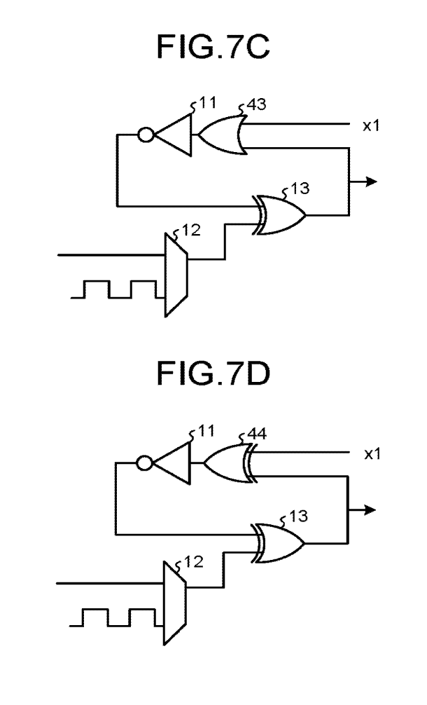

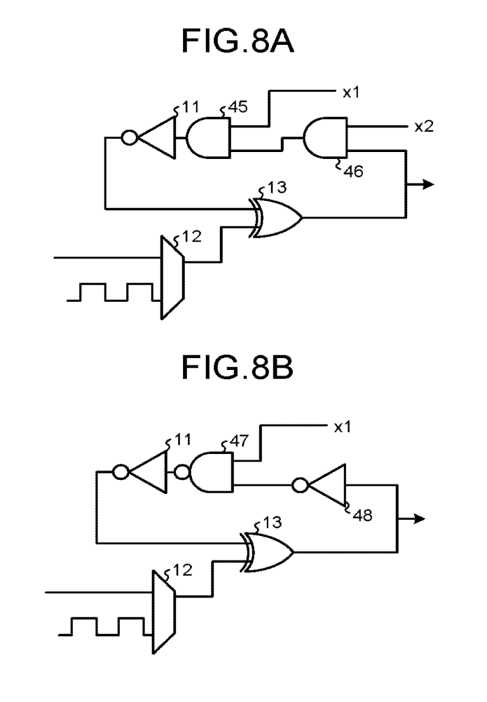

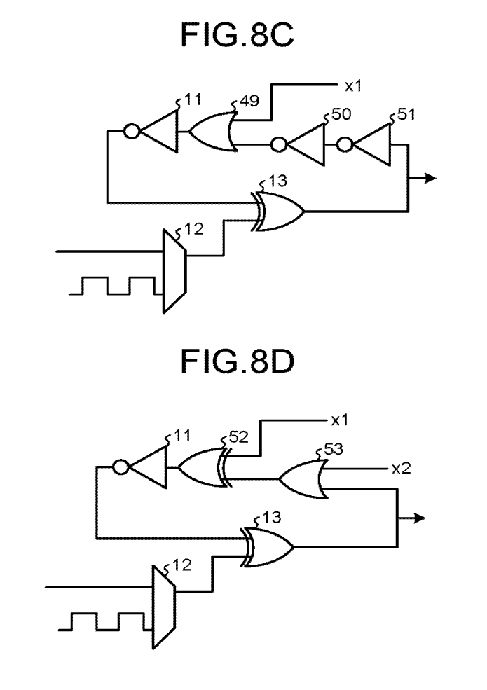

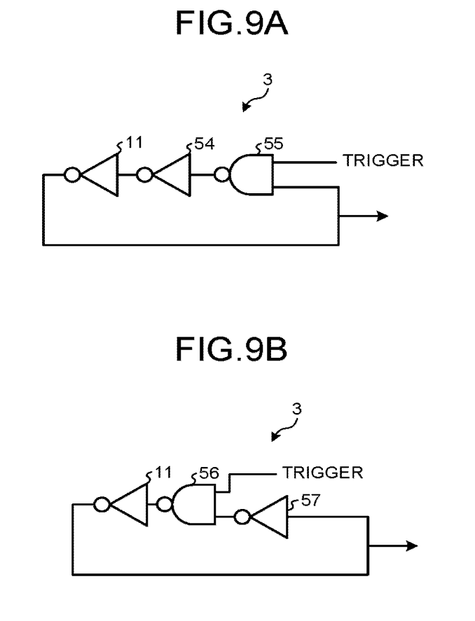

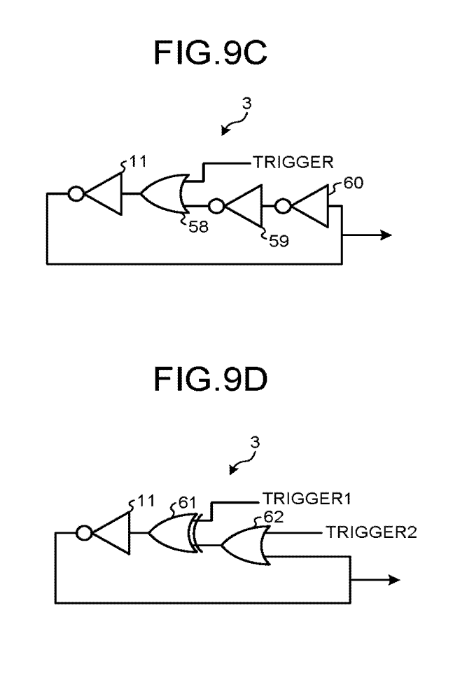

In FIG. 7A to FIG. 7D, FIG. 8A to FIG. 8D, and FIG. 9A to FIG. 9D are illustrated examples of delaying the oscillation frequency by inserting an additional gate circuit in the ring oscillator 3. In FIG. 7A to FIG. 7D are illustrated examples in which a single gate circuit is Inserted. In FIG. 7A is illustrated an example of a circuit configuration in which the output of the inverter 11 is supplied to an AND gate 41, to which a signal (x1) such as a control signal of a separate system is also supplied; and the output of the AND gate 41 is supplied to the XOR gate 13. In this case, in the AND gate 41, the oscillation frequency of the ring oscillator 3 can be delayed. Moreover, by supplying the signal (x1) of a separate system, the initial value of the ring oscillator 3 can be controlled. For example, if the signal (x1) of a separate system is input, the data in the ring oscillator 3 can be initialized.

In an identical manner, in FIG. 7B is illustrated an example in which an AND gate 42, to which the signal (x1) such as a control signal of a separate system is supplied, is inserted in between the output of the XOR gate 13 and the input of the inverter 11. In FIG. 7C is illustrated an example in which an OR gate 43, to which the signal (x1) such as a control signal of a separate system is supplied, is inserted in between the output of the XOR gate 13 and the input of the inverter 11. In FIG. 7D is illustrated an example in which an XOR gate 44, to which the signal (x1) such as a control signal of a separate system is supplied, is inserted in between the output of the XOR gate 13 and the input of the inverter 11. In these examples, by adding the gates 42 to 44 as delay circuits, the oscillation frequency of the ring oscillator 3 can be delayed. Besides, as a result of supplying the signal (x1) of a separate system, the initial value of the ring oscillator 3 can be controlled.

In FIG. 8A is illustrated an example in which two successive AND gates 45 and 46 are inserted in between the output of the XOR gate 13 and the input of the inverter 11. To the AND gates 45 and 46, a signal (x1 and x2, respectively) such as a control signal of a separate system is supplied. Similarly, in FIG. 8B is illustrated an example in which a NAND gate 47, to which a signal (x1) such as a control signal of a separate system is supplied, and an inverter 48, which inverts the output of the XOR gate 13 and inputs the inverted output to the NAND gate 47, are inserted in between the output of the XOR gate 13 and the input of the inverter 11. In FIG. 8C is illustrated an example in which an OR gate 49, to which a signal (x1) such as a control signal of a separate system is supplied, and two successive inverters 50 and 51, to which the output of the XOR gate 13 is supplied, are inserted in between the output of the XOR gate 13 and the input of the inverter 11. In FIG. 8D is illustrated an example in which an OR gate 52, to which a signal (x1) such as a control signal of a separate system is supplied, and an OR gate 53, to which the output of the XOR gate 13 and a signal (x2) such as a control signal of a separate system are supplied, are inserted in between the output of the XOR gate 13 and the input of the inverter 11. In these examples, because of adding the gates 45 to 53 as delay circuits, the oscillation frequency of the ring oscillator 3 can be delayed. Besides, as a result of supplying the signal (x1 or x2) of a separate system, the initial value of the ring oscillator 3 can be controlled.

In FIG. 9A to FIG. 9D are examples in which the ring oscillator 3 includes a single inverter 11 and includes a plurality of gates mainly for the purpose of delaying the oscillation frequency. More particularly, the ring oscillator 3 illustrated in FIG. 9A includes a NAND gate 55, to which the output and the trigger of the ring oscillator 3 is input, and an inverter 54, which inverts the output of the NAND gate 55 and supplies the inverted output to the inverter 11. Similarly, the ring oscillator 3 illustrated in FIG. 9B includes an inverter 57, which inverts the output of the ring oscillator 3, and a NAND gate 56, which supplies to the inverter 11 the output corresponding to the output and the trigger of the inverter 57. Moreover, the ring oscillator 3 illustrated in FIG. 9C includes an inverter 60 that inverts the output of the ring oscillator 3; includes an inverter 50 that inverts the output of the inverter 60; and an OR gate 58 that supplies to the inverter 11 the output corresponding to the output and the trigger corresponding to an inverter 59. Furthermore, the ring oscillator 3 illustrated in FIG. 9D includes an OR gate to which the output and a second trigger (trigger2) of the ring oscillator 3 is input; and includes an XOR gate 61 that supplies to the inverter 11 the output and a first trigger (trigger1) of an OR gate 62. In these examples, because of adding the gates 54 to 62 as delay circuits, the oscillation frequency of the ring oscillator 3 can be delayed. Besides, the oscillation timing can be controlled using the triggers.

As explained with reference to FIG. 7A to FIG. 7D, FIG. 8A to FIG. 8D, and FIG. 9A to FIG. 9D; if the oscillation frequency of the ring oscillator 3 is reduced even if only slightly as a result of inserting additional gates such as inverters, AND circuits, or OR circuits in the ring oscillator 3, then the ID is expressed with more robustness. For that reason, in the ID generating system according to the fourth embodiment, the oscillation frequency can be delayed thereby making it easier to generate the ID (thereby making the ID generation more robust). Meanwhile, regardless of whether a plurality of ring oscillators 3 is disposed or a single ring oscillator 3 is disposed, it is possible to achieve the effect described above.

### Fifth Embodiment

Given below is the explanation of an ID generating system according to a fifth embodiment. In the ID generating system according to the fifth embodiment, the ID is generated from the difference between the outputs of two or more ring oscillators 3, which are arranged neighboring or adjacent to each other, so as to reduce the variation of the external physical environment in which the ring oscillators 3 are present. As compared to the embodiments described above, the fifth embodiment differs regarding only this point. Hence, the following explanation is given only about the differences between the embodiments, and the redundant explanation is not repeated.

The ring oscillators 3 that are arranged neighboring or adjacent to each other are more likely to be affected by the substantially same physical variation of the external physical environment. For example, if there is a temperature variation in the random number generating circuit 1, it is believed that a number of ring oscillators get affected at the same by the same temperature variation. Accordingly, if the differences between the outputs of a plurality of ring oscillators 3, which is arranged neighboring or adjacent to each other, are obtained; then it becomes possible to reduce the effect of the variation in the external physical environment on the ring oscillators 3. Meanwhile, although the following explanation is given for an example in which a plurality of ring oscillators 3 is arranged, the same effect (described later) can be achieved even if only a single ring oscillator 3 is disposed.

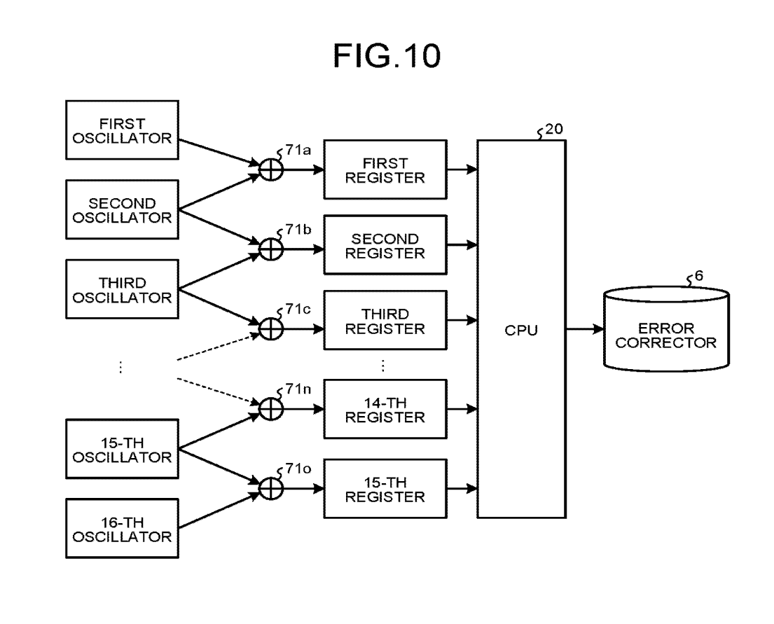

In FIG. 10 to FIG. 12 are illustrated examples in which XOR gates are inserted in between neighboring ring oscillators 3. That is, in the example illustrated in FIG. 10, a first XOR gate 71a detects the difference between the output of a first oscillator and the output of a second output and stores the difference in a first register; while a second XOR gate 71b detects the difference between the output of the second oscillator and the output of a third output and stores the difference in a second register. In an identical manner, a 15-th XOR gate 710 detects the difference between the output of a 15-th oscillator and the output of a 16-th output and stores the difference in a 15-th register. Herein, the first XOR gate 71a to the 15-th XOR gate 710 are examples of a difference detector. The CPU 20 of the ID generator 2 generates an ID by referring to the differences between the neighboring ring oscillators 3 as stored in the first to 15-th registers. As a result, it becomes possible to reduce the effect of the variation in the external physical environment in which the ring oscillators 3 are present, and to generate a reliable, stable ID.

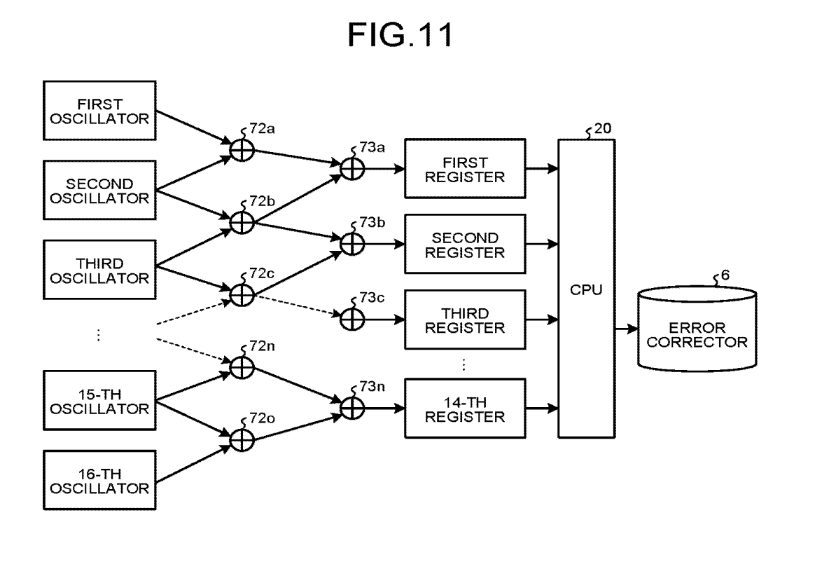

In the example illustrated in FIG. 11, first-level XOR gates detect the differences between the outputs of neighboring ring oscillators, and second-level XOR gates detect the differences between the differences detected by the first-level XOR gates. In this example, a first XOR gate 72a to a 15-th XOR gate 72o illustrated in FIG. 11 represent the first-level XOR gates. Moreover, a first XOR gate 73a to a 14-th XOR gate 73n illustrated in FIG. 11 represent the second-level XOR gates. Herein, the first XOR gate 72a to the 15-th XOR gate 72o, and the first XOR gate 73a to the 14-th XOR gate 73n are examples of the difference detector. The first XOR gate 72a to the 15-th XOR gate 72o arranged at the first level detect the differences between the outputs of neighboring oscillators from a first oscillator to a 16-th oscillator. The first XOR gate 73a to the 14-th XOR gate 73n arranged at the second level detect the differences between the neighboring differences which are detected by the XOR gates 72a to 72n arranged at the first level; and store the differences in a first register to a 14-th register. The CPU 20 of the ID generator 2 generates an ID by referring to the differences between the differences as stored in the first to 14-th registers. As a result, it becomes possible to further reduce the effect of the variation in the external physical environment in which the ring oscillators 3 are present, and to generate an more reliable, stable ID.

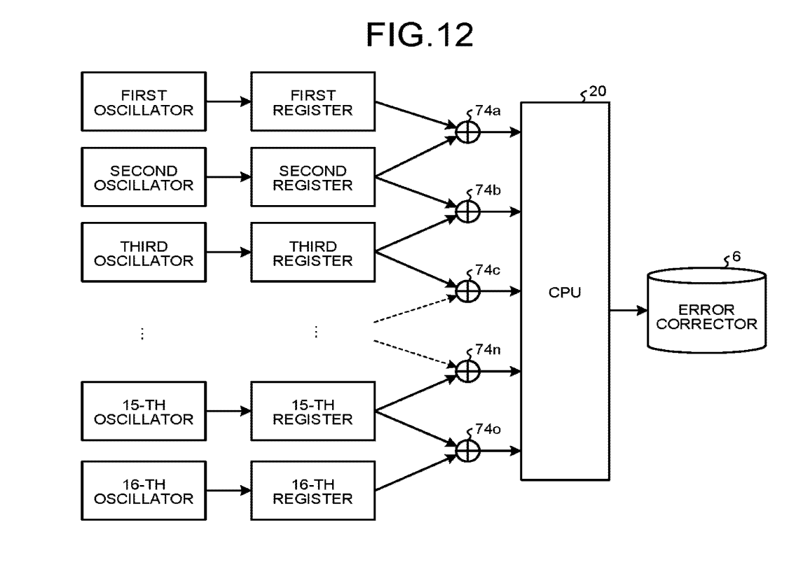

In the example illustrated in FIG. 12, of a first to 16-th registers used in storing the outputs of a first to 16-th ring oscillators, respectively; the differences between the outputs stored in the neighboring registers is detected by a first XOR gate 74a to a 15-th XOR gate 74o. Herein, the first XOR gate 74a to the 15-th XOR gate 74o are examples of the difference detector. The CPU 20 of the ID generator 2 generates an ID by referring to the differences between the outputs stored in the neighboring registers. As a result, it becomes possible to reduce the effect of the variation in the external physical environment in which the ring oscillators 3 are present, and to generate a reliable, stable ID.

Meanwhile, instead of XOR gates, it is possible use binary counters; and the difference between the data of two ring oscillators can be detected according to the number of counters in neighboring ring oscillators. Moreover, in the examples illustrated in FIG. 10 to FIG. 12, it is illustrated that an XOR gate operation of two ring oscillators 3 is obtained. However, alternatively, ID generation can be performed according to the result of obtaining the differences between the outputs of three or more ring oscillators 3 using XOR gates or counters.

Meanwhile, alternatively, the CPU 20 can perform the operations of the abovementioned XOR gates. In that case, it is possible to take exclusive OR of the data of two arbitrary ring oscillators 3. For example, firstly, XOR is taken with respect to the data at the start of operations of two ring oscillators 3 at a time, and the result is treated as first set of 64-bit data. Four such pairs are generated and combined so that a 256-bit key can be generated. Depending on the manner of pairing, it is possible to generate keys equal in number to the factorial of four (equal in number to 4×3×2×1).

In the case of correcting the ID using the obtained data, it is possible to implement an error correcting method such as the “hamming code”, the “BCH (Bose-Chaudhuri-Hocquenghem)”, the “Reed-Solomon code”, or the convolution code. Moreover, as far as the data is concerned, it is possible to make use of data subjected to discrete Fourier transform. That is done because, if the data undergoes changes due to a physical external cause, the features of the structure of 0 and 1 can be captured.

Furthermore, the data obtained by implementing a random number verification method, such as the frequency of appearance of 1, can be used in combination for ID authorization. As the random number verification method, it is possible to implement a verification method such as MIST-SP800-22 or AIS31. Herein, NIST stands for “National Institute of Standards and Technology”. Moreover, SP800 represents the guidelines related to computer security published by CSD (Computer Security Division) of the NIST. Furthermore, AIS31 represents the domestic guidelines for CC evaluation for a hardware random number generator. Herein, CC implies information security international valuation standards (Common Criteria).

Meanwhile, as a measure against the temperature variation, a temperature sensor circuit can be inserted to detect the temperature of the ring oscillator 3, and the effect of temperature variation can be corrected by performing software control.

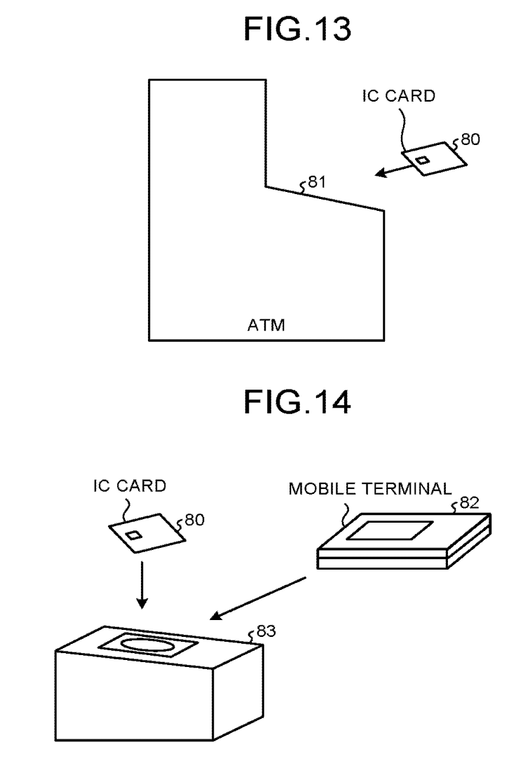

In FIG. 13 to FIG. 16 are illustrated examples of use of the ID generating system according to the embodiments. In the example of use illustrated in FIG. 13, when an IC card 80, in which the ID generating system according to the embodiments is implemented, is moved closer to an ATM (Automated Teller Machine) 81; a server device issues, via the ATM, a command to the IC card 80 to read the ID of the user (i.e., issues a challenge). In response to the command, the pattern (bit string) of 0 and 1 of the random number generating circuit 1 of the IC card 80 of the user is read as the ID, and pattern information is sent to the server device (i.e., a response is given).

In the server device, an estimated ID pattern of the user, which is as estimated from deterioration changes by taking into account the reading count and the reading count, is registered. The server device confirms whether the registered ID pattern matches with the ID pattern of the IC card 80 of the user as received in the response. If both ID patterns are matching, the user authentication is successful.

The example illustrated in FIG. 13 is about implementing the ID generating system according to the embodiments in the IC card 80. However, aside from the IC card 80, the ID generating system according to the embodiments can be implemented in a mobile terminal 82 of every type, such as a cellular phone, a smartphone, or a tablet PC, as illustrated in FIG. 14. In that case, the authentication process is carried out via a mobile reader 83.

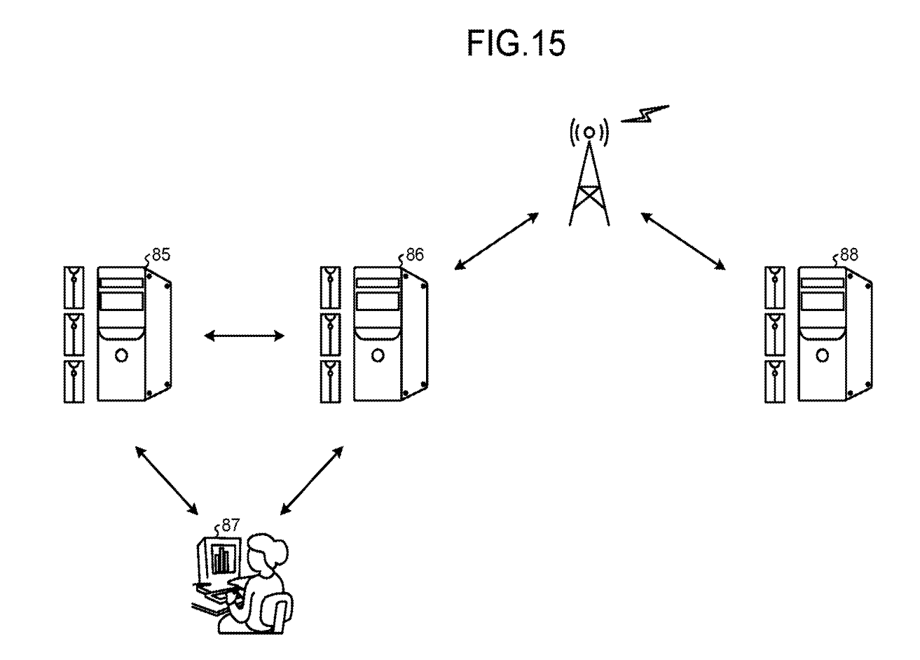

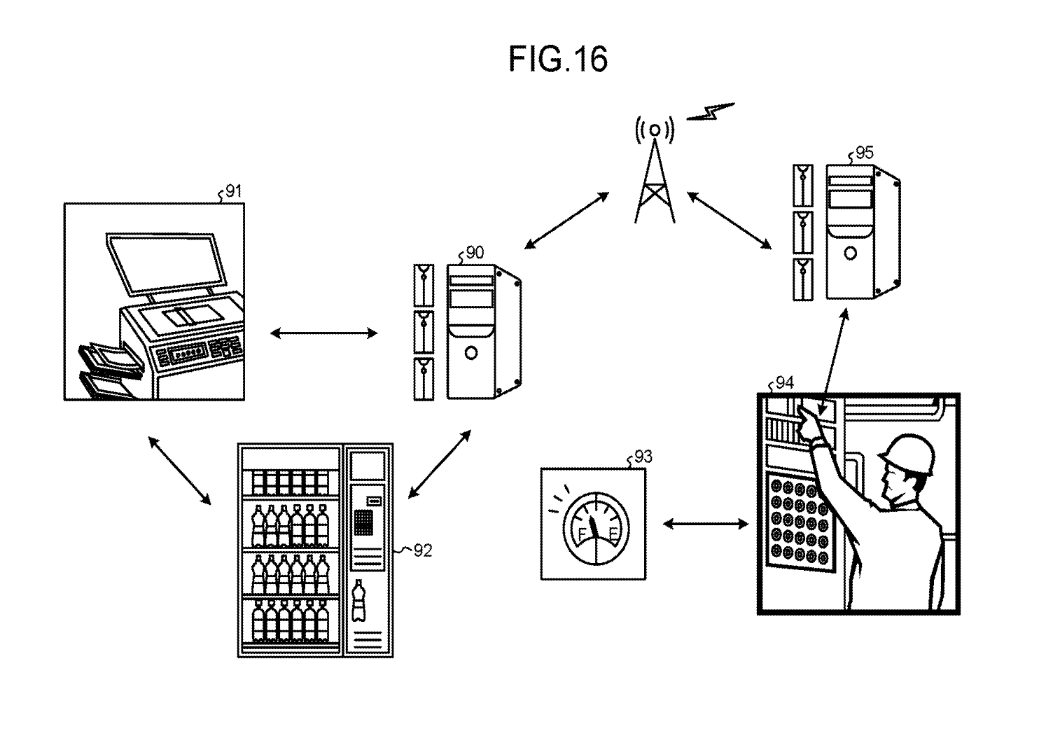

In FIG. 15 and FIG. 16 are illustrated examples in which the ID generating system according to the embodiments is implemented in machine-to-machine (M2M) two-way authentication. In the example illustrated in FIG. 15, authentication is performed between server devices 85 and 86, and authentication is performed between the server device 85 or the server device 86 and a personal computer device 87. As is the case of transmission and reception of signals between the server device 86 and a server device 88, the authentication process can be performed using wireless communication or using radio waves. In the example illustrated in FIG. 16, the ID generating system according to the embodiments is implemented in: two-way authentication between a server device 90 and a network-compatible multifunction peripheral 91; two-way authentication between the server device 90 and a network-compatible automatic vending machine 92; two-way authentication between the network-compatible multifunction peripheral 91 and the network-compatible automatic vending machine 92; two-way authentication between a smart meter 93, such as an electric meter or a gas meter, and a needle detector 94; and two-way authentication between the needle detector 94 and a server device 95. Among the devices 90 to 95, the authentication process can be performed using wireless communication or using radio waves.

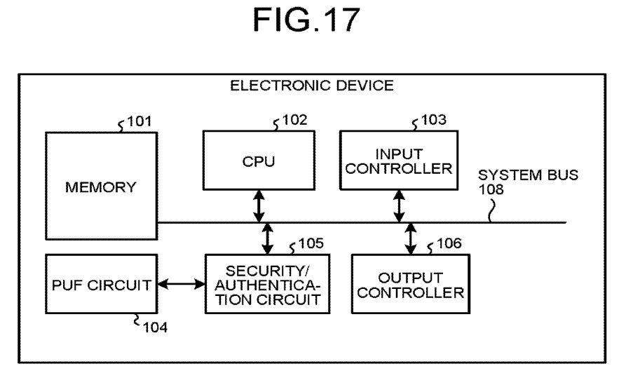

In FIG. 17 is illustrated a block diagram of an electronic device, such as an IC card, in which the ID generating system according to the embodiments is implemented. As illustrated in FIG. 17, the electronic device includes a memory 101, a CPU 102, an input controller 103, a PUF (Physically Unclonable function) circuit 104, a security/authentication circuit 105, and an output controller 106. The constituent elements from the memory 101 to the output controller 106 are connected to each other via a system bus 108. Herein, the PUF circuit 104 represents the ID generating system explained with reference to FIG. 1.

In the electronic device illustrated in FIG. 17, an input signal (i.e., a challenge) issues a response request to the security/authentication circuit 105. Then, the security/authentication circuit 105 accesses the PUF circuit 104 in the electronic device, and obtains the ID, described above, from the PUF circuit 104. The output controller 106 sends the obtained ID to a server device (i.e., gives a response). Then, the server device confirms the ID, which is obtained from the electronic device, by collating the ID with the estimated variation in defect irregularity, and performs user authentication.

### Sixth Embodiment

Given below is the explanation of an ID generating system according to a sixth embodiment. The ID generating system according to the sixth embodiment is also implementable in the examples of use explained with reference to FIG. 13 to FIG. 16.

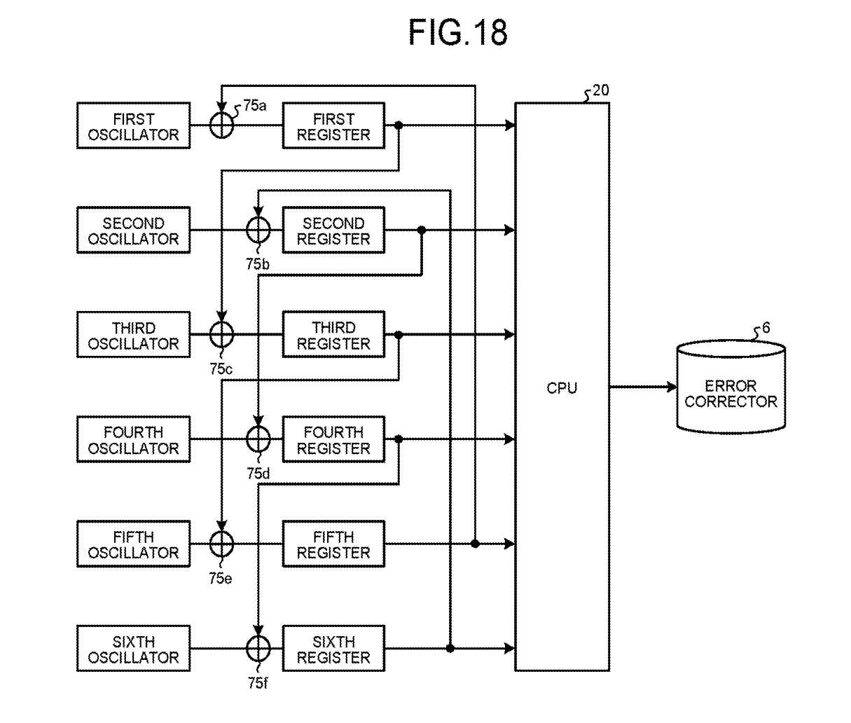

FIG. 18 is a block diagram of the ID generating system according to the sixth embodiment. For the purpose of illustration, six oscillators are illustrated in FIG. 18. However, it is also possible to have a different number of oscillators. For example, as illustrated in FIG. 5, FIG. 10, FIG. 11, and FIG. 12; it is possible to use 16 oscillators or eight oscillators. In the ID generating system according to the sixth embodiment, in order to randomize the data among the ring oscillators as illustrated in FIG. 18, a bit shift operation is performed among the ring oscillators.

More particularly, in the ID generating system according to the sixth embodiment, a total of six oscillators from a first oscillator to a sixth oscillator are used as an example. Herein, as long as a plurality of oscillators, such as two oscillators or four oscillators, is used, it serves the purpose. Moreover, in the ID generating system according to the sixth embodiment, in a corresponding manner to the six oscillators, a first XOR gate 75a to 75f and a first register to a sixth register are disposed.

The output terminal of the first register is connected to the CPU 20 and the third XOR gate 75c. The output terminal of the second register is connected to the CPU 20 and the fourth XOR gate 75d. The output terminal of the third register is connected to the CPU 20 and the fifth XOR gate 75e. The output terminal of the fourth register is connected to the CPU 20 and the sixth XOR gate 75f. The output terminal of the fifth register is connected to the CPU 20 and the first XOR gate 75a. The output terminal of the sixth register is connected to the CPU 20 and the second XOR gate 75b.

In such an ID generating system according to the sixth embodiment, exclusive OR (XOR) is calculated between the pre-registration data of each ring oscillator and the post-registration of another ring oscillator, and the data among the ring oscillators is randomized.

More particularly, the first XOR gate 75a takes exclusive OR between the pre-registration data of the first oscillator and the post-registration data output from the fifth register, and stores the result in the first register. The second XOR gate 75b takes exclusive OR between the pre-registration data of the second oscillator and the post-registration data output from the sixth register, and stores the result in the second register. The third XOR gate 75c takes exclusive OR between the pre-registration data of the third oscillator and the post-registration data output from the first register, and stores the result in the third register. The fourth XOR gate 75d takes exclusive OR between the pre-registration data of the fourth oscillator and the post-registration data output from the second register, and stores the result in the fourth register. The fifth XOR gate 75e takes exclusive OR between the pre-registration data of the fifth oscillator and the post-registration data output from the third register, and stores the result in the fifth register. The sixth XOR gate 75f takes exclusive OR between the pre-registration data of the sixth oscillator and the post-registration data output from the fourth register, and stores the result in the sixth register.

In this example, it is assumed that the third XOR gate 75c performs exclusive OR calculation using the data output from the first register, and that the fourth XOR gate 75d performs exclusive OR calculation using the data output from the second register. That is, among the XOR gates 75a to 75f, exclusive OR calculation is performed using the data output from the register two registers before. Alternatively, for example, the third XOR gate 75c can perform exclusive OR calculation using the data output from the second register; and the fourth XOR gate 75d can perform exclusive OR calculation using the data output from the third register. That is, exclusive OR calculation can be performed using the data output from the register one register before. Still alternatively, for example, the fourth XOR gate 75d can perform exclusive OR calculation using the data output from the first register, and the fifth XOR gate 75e can perform exclusive OR calculation using the data output from the second register. That is, exclusive OR calculation can be performed using the data output from the register three registers before. As long as the data used in exclusive OR calculation is obtained from some other register, the data output from an arbitrary register can be used according to the design. Meanwhile, when 16 oscillators are disposed, the first XOR gate 75a uses the data output from the 15-th register, and the second XOR gate 75b uses the data output from the 16-th register.

As compared to the ID generating system according to the fifth embodiment explained with reference to FIG. 10 to FIG. 12, in the ID generating system according to the sixth embodiment, the data of all ring oscillators can be randomized. That enables achieving further reduction in the effect of variation in the external physical environment. Moreover, in the case in which the ring oscillators are positioned apart from each other on a circuit board due to the layout routing of the circuit, the ID generating system according to the sixth embodiment functions in an effective manner.

### Seventh Embodiment

Given below is the explanation of an ID generating system according to a seventh embodiment. Herein, the ID generating system according to the seventh embodiment is also implementable in the examples of use explained with reference to FIG. 13 to FIG. 16.

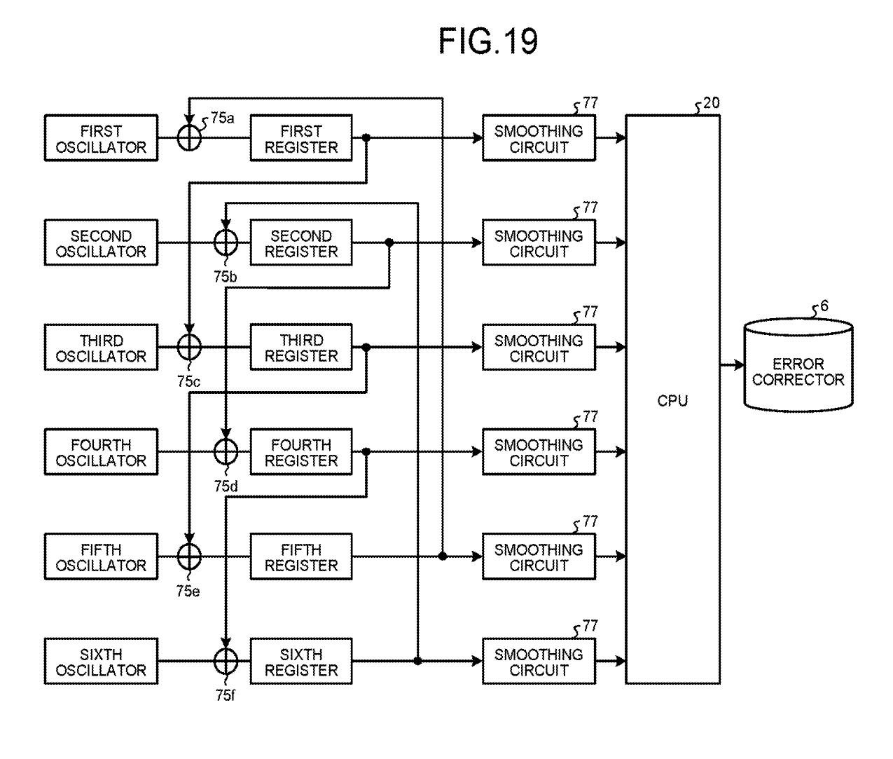

FIG. 19 is a block diagram illustrating an ID generating system according to the seventh embodiment. As illustrated in FIG. 19, in the ID generating system according to the seventh embodiment, smoothing circuits 77, which perform smoothing of the output from the registers and supply the post-smoothing output to the CPU 20, are disposed in the configuration of the ID generating system according to the sixth embodiment.

As described above, depending on the oscillation environment of a ring oscillator, there are times when the random numbers generated at the start of operations exhibit variability. In such a case, the data generated at the start of operations of the ring oscillators 3 is subjected to smoothing by the smoothing circuits 77. As a result, not only it becomes possible to hold down the variability in the random numbers generated at the start of operations of the ring oscillator 3, but also it becomes possible to achieve the same effect as the sixth embodiment.

Aside from that, a linear feedback shift register can be additionally disposed for the purpose of masking the data. Meanwhile, with reference to FIG. 19, in order to provide a comprehensible explanation, the example is given in which six oscillators are used. However, any other number of oscillators can be used. For example, as illustrated in FIG. 5, FIG. 10, FIG. 11, and FIG. 12; it is possible to use 16 oscillators or eight oscillators.

In the explanation of the embodiments given above, the random number generating circuit 1 includes a plurality of ring oscillators 3. However, even if only a single ring oscillator 3 is disposed, it is possible to achieve the same effect as in the case of having a plurality of ring oscillators 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ID generating device comprising:
a random number generator configured to generate random numbers;
a storage configured to store random numbers generated by the random number generator during a predetermined time period starting from activation of the random number generator; and
a generator configured to generate identification information using the random numbers stored in the storage.

2. The device according to claim 1, wherein the predetermined time period is a period starting from activation of the random number generator up to start of generation of stable random numbers.

3. The device according to claim 1, wherein the generator is configured to generate the identification information using a random number that has been generated first at time of activation of the random number generator.

4. The device according to claim 1, wherein the random number generator includes a ring oscillator that includes an uneven number of inverters.

5. The device according to claim 1, further comprising a smoothing circuit configured to average the random numbers read out from the storage.

6. The device according to claim 4, wherein the random number generator includes a delay circuit configured to delay oscillation speed.

7. An ID generating method comprising:
generating, by a random number generator, random numbers;
storing, in a storage, random numbers generated by the random number generator during a predetermined time period starting from activation of the random number generator; and
generating, by a generator, identification information using the random numbers stored in the storage.

8. An ID generating system comprising:
a random number generator configured to generate random numbers;
a storage configured to store random numbers generated by the random number generator during a predetermined time period starting from activation of the random number generator; and
a generator configured to generate identification information using the random numbers stored in the storage;
a code adder configured to add an error correction code to the generated identification information; and
a function adder configured to add a hash function to the identification information to which the error correction code has been added, and output the identification information.

9. The device according to claim 1, wherein
a plurality of random number generators are provided,
the storage is configured to store the random numbers generated by the random number generators during the predetermined time period starting from activation of the random number generators, and
the generator is configured to generate the identification information using the random numbers stored in the storage.

10. The device according to claim 9, wherein the predetermined time period is a period starting from activation of the random number generators up to start of generation of stable random numbers.

11. The device according to claim 9, wherein the generator is configured to generate the identification information using random numbers each having been generated first at time of activation of each of the random number generators.

12. The device according to claim 9, wherein each of the random number generators includes a ring oscillator that includes an uneven number of inverters.

13. The device according to claim 9, further comprising a smoothing circuit configured to average the random numbers read out from the storage.

14. The device according to claim 12, wherein each of the random number generators includes a delay circuit configured to delay oscillation speed.

15. The device according to claim 9, further comprising a difference detector configured to detect a difference between a random number generated by one of the random number generators and a random number generated by another random number generator, wherein
the generator is configured to Generate the identification information using the difference detected by the difference detector.
